(19) United States
(12) Patent Application Publication
(10) Pub. No.: US 2023/0221612 A1
(43) Pub. Date: Jul. 13, 2023

(54) OPTICAL PHASE MODULATOR

(71) Applicant: Mitsubishi Electric Corporation, Tokyo (JP)

(72) Inventors: Masakazu TAKABAYASHI, Chiyoda-ku, Tokyo (JP); Yosuke SUZUKI, Chiyoda-ku, Tokyo (JP); Satoshi NISHIKAWA, Chiyoda-ku, Tokyo (JP)

(73) Assignee: Mitsubishi Electric Corporation, Tokyo (JP)

(21) Appl. No.: 17/920,397

(22) PCT Filed: May 21, 2020
(86) PCT No.: PCT/JP2020/020121

§ 371 Date: Mar. 30, 2023

(51) Int. Cl. G02F 1/21; G02F 1/225

(52) U.S. Cl. CPC G02F 1/212; G02F 1/225

(57) ABSTRACT

An optical phase modulator (2) includes a first 2×2 Mach-Zehnder optical phase modulation unit (10). The first 2×2 Mach-Zehnder optical phase modulation unit (10) includes a first 2×2 multimode interference waveguide (11), a second 2×2 multimode interference waveguide (14), a pair of first arm waveguides (12, 13), and first modulation electrodes (15, 16). A first output port (an output port 17d) of the first 2×2 Mach-Zehnder optical phase modulation unit (10 ) is a cross port to a first input port (an input port 17a) of the first 2×2 Mach-Zehnder optical phase modulation unit (10).

### TECHNICAL FIELD

The present disclosure relates to an optical phase modulator.

### BACKGROUND ART

Japanese Patent No. 6211538 (PTL 1) discloses an optical modulation device including a Mach-Zehnder optical phase modulator and a monitoring photodiode. The Mach-Zehnder phase light modulator includes an optical demultiplexer and an optical multiplexer such as a Y-branched optical waveguide or a directional coupler.

### CITATION LIST

### Patent Literature

PTL 1: Japanese Patent No. 6211538

### SUMMARY OF INVENTION

### Technical Problem

The extinction ratio of the Mach-Zehnder optical phase modulation unit decreases when there is a manufacturing error in the Y-branched optical waveguide or the directional coupler. When the extinction ratio of the Mach-Zehnder optical phase modulation unit decreases, the quality of the optical phase modulation signal output from the Mach-Zehnder optical phase modulation unit decreases. An object of the present disclosure is to provide an optical phase modulator capable of outputting an optical phase modulation signal with an improved quality even when there is a manufacturing error in an optical demultiplexer and an optical multiplexer included in a Mach-Zehnder optical phase modulation unit.

### Solution to Problem

The optical phase modulator of the present disclosure includes a first 2×2 Mach-Zehnder optical phase modulation unit. The first 2×2 Mach-Zehnder optical phase modulation unit includes a first 2×2 multimode interference waveguide, a second 2×2 multimode interference waveguide, a pair of first arm waveguides, and a first modulation electrode. The pair of first arm waveguides connects the first 2×2 multimode interference waveguide and the second 2×2 multimode interference waveguide to each other. The first modulation electrode is disposed corresponding to the pair of first arm waveguides. The first output port of the first 2×2 Mach-Zehnder optical phase modulation unit is a first cross port to the first input port of the first 2×2 Mach-Zehnder optical phase modulation unit.

### Advantageous Effects of Invention

Therefore, a branching ratio deviation of the first 2×2 multimode interference waveguide caused by a manufacturing error of the first 2×2 multimode interference waveguide is canceled by a branching ratio deviation of the second 2×2 multimode interference waveguide caused by a manufacturing error of the second 2×2 multimode interference waveguide. The extinction ratio of the optical phase modulator is improved. Thereby, the quality of the optical phase modulation signal output from the optical phase modulator is improved.

### BRIEF DESCRIPTION OF DRAWINGS

FIG. 1 is a schematic plan view illustrating an optical phase modulation system according to a first embodiment;

FIG. 2 is a schematic cross-sectional view taken along a cross-sectional line II-II illustrated in FIG. 1 and illustrating an optical phase modulator included in the optical phase modulation system according to the first embodiment;

FIG. 3 is a diagram illustrating a simulation result of an extinction ratio of the optical phase modulator included in the optical phase modulation system according to the first embodiment (when there is no manufacturing error in an optical demultiplexer and an optical multiplexer, and the branching ratio deviation of the optical demultiplexer and the optical multiplexer is 0 dB);

FIG. 4 is a diagram illustrating a simulation result of the extinction ratio of the optical phase modulator included in the optical phase modulation system according to the first embodiment (when there is a manufacturing error in the optical demultiplexer and the optical multiplexer, and the branching ratio deviation of the optical demultiplexer and the optical multiplexer is 1 dB);

FIG. 5 is a schematic plan view illustrating an optical phase modulation system according to a second embodiment;

FIG. 6 is a schematic plan view illustrating an optical phase modulation system according to a first modification of the second embodiment;

FIG. 7 is a schematic plan view illustrating an optical phase modulation system according to a second modification of the second embodiment;

FIG. 8 is a schematic plan view illustrating an optical phase modulation system according to a third embodiment;

FIG. 9 is a schematic plan view illustrating an optical phase modulation system according to a modification of the third embodiment;

FIG. 10 is a schematic plan view illustrating an optical phase modulation system according to a fourth embodiment; p FIG. 11 is a schematic cross-sectional view taken along a cross-sectional line XI-XI illustrated in FIG. 10 and illustrating an optical phase modulator included in the optical phase modulation system according to the fourth embodiment;

FIG. 12 is a control block diagram illustrating an optical phase modulator included in the optical phase modulation system according to the fourth embodiment or the fifth embodiment;

FIG. 13 is a schematic plan view illustrating an optical phase modulation system according to a modification of the fourth embodiment; and

FIG. 14 is a schematic plan view illustrating an optical phase modulation system according to a fifth embodiment.

### DESCRIPTION OF EMBODIMENTS

Hereinafter, embodiments of the present disclosure will be described. The same components are denoted by the same reference numerals, and the description thereof will not be repeated.

### First Embodiment

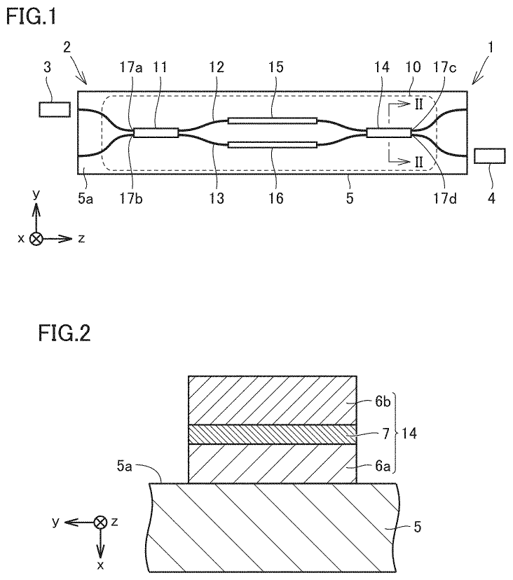

With reference to FIGS. 1 and 2, an optical phase modulation system 1 according to a first embodiment will be described. As illustrated in FIG. 1, the optical phase modulation system 1 includes an optical phase modulator 2, a light-emitting member 3, and a light-receiving member 4.

The light-emitting member 3 is an optical member that emits a light beam such as laser light to the optical phase modulator 2. The light-emitting member 3 includes, for example, at least one of a laser light source such as a semiconductor laser or an optical element such as an optical fiber, a lens, a mirror, a polarizer, a polarization rotator, a wave plate, a beam splitter or a polarization beam splitter.

The optical phase modulator 2 includes a substrate 5 and a first 2×2 Mach-Zehnder optical phase modulation unit 10. The substrate 5 is, for example, a semiconductor substrate such as an InP substrate. The first 2×2 Mach-Zehnder optical phase modulation unit 10 is formed on a main surface 5a of the substrate 5.

The first 2×2 Mach-Zehnder optical phase modulation unit 10 includes a first 2×2 multimode interference waveguide 11, a second 2×2 multimode interference waveguide 14, a pair of first arm waveguides 12 and 13, and first modulation electrodes 15 and 16. In the present specification, “2×2” refers to that a waveguide has two input ports and two output ports.

As illustrated in FIG. 2, the second 2×2 multimode interference waveguide 14 includes a lower cladding layer 6a formed on the main surface 5a of the substrate 5, an optical waveguide layer 7 formed on the lower cladding layer 6a, and an upper cladding layer 6b formed on the optical waveguide layer 7. The optical waveguide layer 7 has a refractive index greater than that of the lower cladding layer 6a and greater than that of the upper cladding layer 6b. The optical waveguide layer 7 is, for example, a bulk semiconductor layer or a multiple quantum well (MQW) layer. The lower cladding layer 6a, the optical waveguide layer 7 and the upper cladding layer 6b are formed of, for example, an InGaAsP-based material. The first 2×2 multimode interference waveguide 11 has the same structure as the second 2×2 multimode interference waveguide 14.

As illustrated in FIG. 1, the first 2×2 Mach-Zehnder optical phase modulation unit 10 (the optical phase modulator 2) includes two input ports 17a and 17b. The input ports 17a and 17b are input ports of the first 2×2 multimode interference waveguide 11. The first 2×2 Mach-Zehnder optical phase modulation unit 10 (the optical phase modulator 2) includes two output ports 17c and 17d. The output ports 17c and 17d are output ports of the second 2×2 multimode interference waveguide 14.

In a plan view of the main surface 5a of the substrate 5, the input port 17a and the output port 17c are disposed on one side (for example, the upper side in FIG. 1) with respect to a center line of the first 2×2 Mach-Zehnder optical phase modulation unit 10 that extends in the longitudinal direction of the first 2×2 Mach-Zehnder optical phase modulation unit 10. In the plan view of the main surface 5a of the substrate 5, the input port 17b and the output port 17d are disposed on the other side (for example, the lower side in FIG. 1) with respect to the center line of the first 2×2 Mach-Zehnder optical phase modulation unit 10 that extends in the longitudinal direction of the first 2×2 Mach-Zehnder optical phase modulation unit 10.

Each of the pair of first arm waveguides 12 and 13 has a laminated structure the same as that of the second 2×2 multimode interference waveguide 14, but has a waveguide width narrower than that of the second 2×2 multimode interference waveguide 14. Each of the pair of first arm waveguides 12 and 13 is a single mode waveguide. The pair of first arm waveguides 12 and 13 connects the first 2×2 multimode interference waveguide 11 and the second 2×2 multimode interference waveguide 14 to each other. The pair of first arm waveguides 12 and 13 is connected to two output ports of the first 2×2 multimode interference waveguide 11, respectively. The pair of first arm waveguides 12 and 13 is connected to two input ports of the second 2×2 multimode interference waveguide 14, respectively.

The first modulation electrodes 15 and 16 are disposed corresponding to the pair of first arm waveguides 12 and 13. In one example, the first modulation electrodes 15 and 16 are disposed on the pair of first arm waveguides 12 and 13. The first modulation electrodes 15 and 16 each may be a traveling wave electrode. When a first modulation voltage applied to the first modulation electrodes 15 and 16 is changed, the refractive index of the pair of first arm waveguides 12 and 13 is changed. Thereby, the phase of light propagating through the pair of first arm waveguides 12 and 13 is modulated. The phase-modulated light passes through the second 2×2 multimode interference waveguide 14, and is emitted from the first 2×2 Mach-Zehnder optical phase modulation unit 10 (the optical phase modulator 2) as a phase-modulated optical signal.

The light-receiving member 4 is an optical member that receives the phase-modulated optical signal emitted from the optical phase modulator 2. The light-receiving member 4 includes, for example, at least one of an optical amplifier such as a semiconductor optical amplifier (SOA), a photodetector such as a photodiode, or an optical element such as an optical fiber, a lens, a mirror, a polarizer, a polarization rotator, a wave plate, a beam splitter or a polarization beam splitter.

In the present embodiment, the first output port of the first 2×2 Mach-Zehnder optical phase modulation unit 10 is a first cross port to the first input port of the first 2×2 Mach-Zehnder optical phase modulation unit 10.

Specifically, as illustrated in FIG. 1, the input port 17a of the first 2×2 Mach-Zehnder optical phase modulation unit 10 is a first input port of the first 2×2 Mach-Zehnder optical phase modulation unit 10. The output port 17d of the first 2×2 Mach-Zehnder optical phase modulation unit 10 is a first output port of the first 2×2 Mach-Zehnder optical phase modulation unit 10. The input waveguide connected to the input port 17a extends to a first end face of the substrate 5. The light-emitting member 3 faces the input waveguide. The light is emitted from the light-emitting member 3 to the input port 17a. The output waveguide connected to the output port 17d extends to a second end face of the substrate 5. The light-receiving member 4 faces the output waveguide. The phase-modulated optical signal is emitted from the output port 17d toward the light-receiving member 4.

Similarly, in a modification of the present embodiment, the first output port of the first 2×2 Mach-Zehnder optical phase modulation unit 10 is a first cross port to the first input port of the first 2×2 Mach-Zehnder optical phase modulation unit 10.

Specifically, the input port 17b of the first 2×2 Mach-Zehnder optical phase modulation unit 10 is a first input port of the first 2×2 Mach-Zehnder optical phase modulation unit 10. The output port 17c of the first 2×2 Mach-Zehnder optical phase modulation unit 10 is a first output port of the first 2×2 Mach-Zehnder optical phase modulation unit 10. The input waveguide connected to the input port 17b extends to the first end face of the substrate 5. The light-emitting member 3 faces the input waveguide. The light is emitted from the light-emitting member 3 to the input port 17b. The output waveguide connected to the output port 17c extends to the second end face of the substrate 5. The light-receiving member 4 faces the output waveguide. The phase-modulated optical signal is emitted from the output port 17c toward the light-receiving member 4.

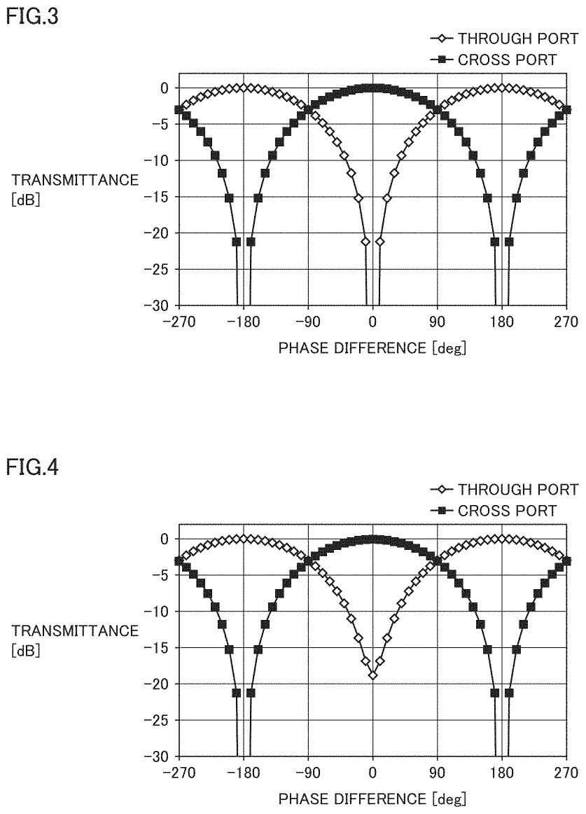

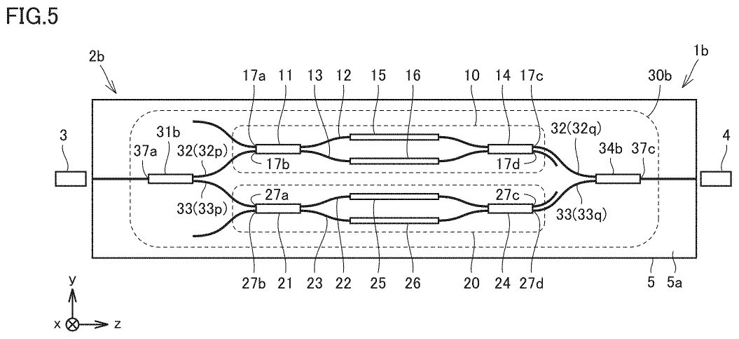

The effects of the present embodiment will be described with reference to FIGS. 3 and 4. In FIGS. 3 and 4, the vertical axis represents a transmittance of a light beam to a cross port and a transmittance of a light beam to a through port in the first 2×2 Mach-Zehnder optical phase modulation unit 10 (the optical phase modulator 2), and the horizontal axis represents a phase difference between a light beam passing through the first arm waveguide 12 and a light beam passing through the first arm waveguide 13, the phase difference being determined by a first modulation voltage applied from the first modulation electrodes 15 and 16 to the first arm waveguides 12 and 13.

In order to improve the quality of the optical phase modulation signal output from the optical phase modulator 2 (the first 2×2 Mach-Zehnder optical phase modulation unit 10), it is necessary to improve the extinction ratio of the optical phase modulator 2 (the first 2×2 Mach-Zehnder optical phase modulation unit 10).

With reference to FIG. 3, the extinction ratio of the optical phase modulator 2 (the first 2×2 Mach-Zehnder optical phase modulation unit 10) will be described when there is no manufacturing error in the first 2×2 multimode interference waveguide 11 and the second 2×2 multimode interference waveguide 14 and there is no branching ratio deviation in each of the first 2×2 multimode interference waveguide 11 and the second 2×2 multimode interference waveguide 14 (in other words, the branching ratio deviation is 0 dB). For example, when there is no branching ratio deviation in the first 2×2 multimode interference waveguide 11, it means that when a light beam is emitted from one input port (for example, the input port 17a) of the first 2×2 multimode interference waveguide 11, the ratio between the light intensity of a light beam output to the first arm waveguide 12 and the light intensity of a light beam output to the second arm waveguide is 50:50.

In this case, the extinction ratio of the optical phase modulator 2 (the first 2×2 Mach-Zehnder optical phase modulation unit 10) does not decrease regardless of whether the output port of the first 2×2 Mach-Zehnder optical phase modulation unit 10 is a cross port to the input port of the first 2×2 Mach-Zehnder optical phase modulation unit 10 or a through port to the input port of the first 2×2 Mach-Zehnder optical phase modulation unit 10.

With reference to FIG. 4, the extinction ratio of the optical phase modulator 2 (the first 2×2 Mach-Zehnder optical phase modulation unit 10) will be described when there is a manufacturing error in the first 2×2 multimode interference waveguide 11 and the second 2×2 multimode interference waveguide 14 and there is a branching ratio deviation in each of the first 2×2 multimode interference waveguide 11 and the second 2×2 multimode interference waveguide 14 (for example, the branching ratio deviation is 1 dB). For example, when the branching ratio deviation in the first 2×2 multimode interference waveguide 11 is 1 dB, it means that when a light beam is emitted from one input port (for example, the input port 17a) of the first 2×2 multimode interference waveguide 11, the ratio between the light intensity of a light beam output to the first arm waveguide 12 and the light intensity of a light beam output to the second arm waveguide is 44.2:55.8 or 55.8:44.2.

In this case, the extinction ratio of the optical phase modulator 2 (the first 2×2 Mach-Zehnder optical phase modulation unit 10) decreases when the output port of the first 2×2 Mach-Zehnder optical phase modulation unit 10 is a through port to the input port of the first 2×2 Mach-Zehnder optical phase modulation unit 10. On the other hand, when the output port of the first 2×2 Mach-Zehnder optical phase modulation unit 10 is a cross port to the input port of the first 2×2 Mach-Zehnder optical phase modulation unit 10, the extinction ratio of the optical phase modulator 2 (the first 2×2 Mach-Zehnder optical phase modulation unit 10) does not decrease. The reason therefor is that when the output port of the first 2×2 Mach-Zehnder optical phase modulation unit 10 is a cross port to the input port of the first 2×2 Mach-Zehnder optical phase modulation unit 10, the branching ratio deviation of the first 2×2 multimode interference waveguide 11 caused by a manufacturing error of the first 2×2 multimode interference waveguide 11 is canceled by the branching ratio deviation of the second 2×2 multimode interference waveguide 14 caused by a manufacturing error of the second 2×2 multimode interference waveguide 14.

Thus, when the output port of the first 2×2 Mach-Zehnder optical phase modulation unit 10 is a cross port to the input port of the first 2×2 Mach-Zehnder optical phase modulation unit 10, the extinction ratio of the optical phase modulator 2 (the first 2×2 Mach-Zehnder optical phase modulation unit 10) is improved. Thereby, the quality of the optical phase modulation signal output from the optical phase modulator 2 (the first 2×2 Mach-Zehnder optical phase modulation unit 10) is improved.

Effects of the optical phase modulator 2 of the present embodiment will be described.

The optical phase modulator 2 of the present embodiment includes a first 2×2 Mach-Zehnder optical phase modulation unit 10. The first 2×2 Mach-Zehnder optical phase modulation unit 10 includes a first 2×2 multimode interference waveguide 11, a second 2×2 multimode interference waveguide 14, a pair of first arm waveguides 12 and 13, and first modulation electrodes 15 and 16. The pair of first arm waveguides 12 and 13 connects the first 2×2 multimode interference waveguide 11 and the second 2×2 multimode interference waveguide 14 to each other. The first modulation electrodes 15 and 16 are disposed corresponding to the pair of first arm waveguides 12 and 13. The first output port (for example, the output port 17d) of the first 2×2 Mach-Zehnder optical phase modulation unit 10 is a first cross port to the first input port (for example, the input port 17a) of the first 2×2 Mach-Zehnder optical phase modulation unit 10.

The first 2×2 multimode interference waveguide 11 is an optical demultiplexer in the first 2×2 Mach-Zehnder optical phase modulation unit 10. The second 2×2 multimode interference waveguide 14 is an optical multiplexer in the first 2×2 Mach-Zehnder optical phase modulation unit 10. The multimode interference waveguide has a branching ratio deviation caused by a manufacturing error smaller than that of a Y-branched optical waveguide or a directional coupler. Therefore, the extinction ratio of the optical phase modulator 2 (the first 2×2 Mach-Zehnder optical phase modulation unit 10) is improved. Thereby, the quality of the optical phase modulation signal output from the optical phase modulator 2 (the first 2×2 Mach-Zehnder optical phase modulation unit 10) is improved.

Further, the first output port (for example, the output port 17d) of the first 2×2 Mach-Zehnder optical phase modulation unit 10 is a first cross port to the first input port (for example, the input port 17a) of the first 2×2 Mach-Zehnder optical phase modulation unit 10. Therefore, the branching ratio deviation of the first 2×2 multimode interference waveguide 11 caused by a manufacturing error of the first 2×2 multimode interference waveguide 11 is canceled by the branching ratio deviation of the second 2×2 multimode interference waveguide 14 caused by a manufacturing error of the second 2×2 multimode interference waveguide 14. The extinction ratio of the optical phase modulator 2 (the first 2×2 Mach-Zehnder optical phase modulation unit 10) is improved. Thereby, the quality of the optical phase modulation signal output from the optical phase modulator 2 is improved.

### Second Embodiment

An optical phase modulation system 1b according to a second embodiment will be described with reference to FIG. 5. The optical phase modulation system 1b of the present embodiment has a structure similar to that of the optical phase modulation system 1 of the first embodiment, but is mainly different from the optical phase modulation system 1 in that the optical phase modulation system 1b of the present embodiment includes an optical phase modulator 2b instead of the optical phase modulator 2 of the first embodiment. The optical phase modulator 2b has a structure similar to that of the optical phase modulator 2 of the first embodiment, but is mainly different from the optical phase modulator 2 on the following points.

The optical phase modulator 2b further includes a second 2×2 Mach-Zehnder optical phase modulation unit 20 and a Mach-Zehnder optical waveguide unit 30b. The second 2×2 Mach-Zehnder optical phase modulation unit 20 and the Mach-Zehnder optical waveguide unit 30b are disposed on the main surface 5a of the substrate 5. The optical phase modulator 2b is an IQ (In-phase Quadrature) optical modulator capable of performing quadrature phase shift keying (QPSK).

The second 2×2 Mach-Zehnder optical phase modulation unit 20 has a structure similar to that of the first 2×2 Mach-Zehnder optical phase modulation unit 10. Specifically, the second 2×2 Mach-Zehnder optical phase modulation unit 20 includes a third 2×2 multimode interference waveguide 21, a fourth 2×2 multimode interference waveguide 24, a pair of second arm waveguides 22 and 23, and second modulation electrodes 25 and 26.

The third 2×2 multimode interference waveguide 21 and the fourth 2×2 multimode interference waveguide 24 have the same structure. The third 2×2 multimode interference waveguide 21 has the same structure as the first 2×2 multimode interference waveguide 11.

As illustrated in FIG. 5, the second 2×2 Mach-Zehnder optical phase modulation unit 20 includes two input ports 27a and 27b. The input ports 27a and 27b are input ports of the third 2×2 multimode interference waveguide 21. The second 2×2 Mach-Zehnder optical phase modulation unit 20 includes two output ports 27c and 27d. The output ports 27c and 27d are output ports of the fourth 2×2 multimode interference waveguide 24.

In a plan view of the main surface 5a of the substrate 5, the input port 27a and the output port 27c are disposed on one side (for example, the upper side in FIG. 5) with respect to a center line of the second 2×2 Mach-Zehnder optical phase modulation unit 20 that extends in the longitudinal direction of the second 2×2 Mach-Zehnder optical phase modulation unit 20. In a plan view of the main surface 5a of the substrate 5, the input port 27b and the output port 27d are disposed on the other side (for example, the lower side in FIG. 5) with respect to the center line of the second 2×2 Mach-Zehnder optical phase modulation unit 20 that extends in the longitudinal direction of the second 2×2 Mach-Zehnder optical phase modulation unit 20.

Each of the pair of second arm waveguides 22 and 23 has a laminated structure the same as that of the third 2×2 multimode interference waveguide 21, but has a waveguide width narrower than that of the third 2×2 multimode interference waveguide 21. The pair of second arm waveguides 22 and 23 has the same structure as the pair of first arm waveguides 12 and 13. Each of the pair of second arm waveguides 22 and 23 is a single mode waveguide. The pair of second arm waveguides 22 and 23 connects the third 2×2 multimode interference waveguide 21 and the fourth 2×2 multimode interference waveguide 24 to each other. The pair of second arm waveguides 22 and 23 is connected to two output ports of the third 2×2 multimode interference waveguide 21, respectively. The pair of second arm waveguides 22 and 23 is connected to two input ports of the fourth 2×2 multimode interference waveguide 24, respectively.

The second modulation electrodes 25 and 26 are disposed corresponding to the pair of second arm waveguides 22 and 23. In one example, the second modulation electrodes 25 and 26 are disposed on the pair of second arm waveguides 22 and 23. The second modulation electrodes 25 and 26 each may be a traveling wave electrode. When a second modulation voltage applied to the second modulation electrodes 25 and 26 is changed, the refractive index of the pair of second arm waveguides 22 and 23 is changed. Thereby, the phase of the light propagating through the pair of second arm waveguides 22 and 23 is modulated. The phase-modulated light passes through the fourth 2×2 multimode interference waveguide 24, and is emitted from the second 2×2 Mach-Zehnder optical phase modulation unit 20 as a phase-modulated optical signal.

The Mach-Zehnder optical waveguide unit 30b is a 1×1 Mach-Zehnder optical waveguide unit. In the present specification, “1×1” refers to that a waveguide has one input port and one output port. The Mach-Zehnder optical waveguide unit 30b includes an input port 37a and an output port 37c.

The Mach-Zehnder optical waveguide unit 30b includes a first 1×2 multimode interference waveguide 31b, a 2×1 multimode interference waveguide 34b, and a pair of third arm waveguides 32 and 33. The Mach-Zehnder optical waveguide unit 30b has a laminated structure the same as that of the first 2×2 Mach-Zehnder optical phase modulation unit 10. In the present specification, “1×2” refers to that a waveguide has one input port and two output ports. “2×1” refers to that a waveguide has two input ports and one output port.

The first 1×2 multimode interference waveguide 31b includes one input port and two output ports. The input port 37a of the Mach-Zehnder optical waveguide unit 30b is an input port of the first 1×2 multimode interference waveguide 31b. The 2×1 multimode interference waveguide 34b includes two input ports and one output port. The output port 37c of the Mach-Zehnder optical waveguide unit 30b is an output port of the 2×1 multimode interference waveguide 34b.

The pair of third arm waveguides 32 and 33 has the same structure as the pair of first arm waveguides 12 and 13. Each of the pair of third arm waveguides 32 and 33 is a single mode waveguide. The pair of third arm waveguides 32 and 33 connects the first 1×2 multimode interference waveguide 31b and the 2×1 multimode interference waveguide 34b to each other. The pair of third arm waveguides 32 and 33 is connected to two output ports of the first 1×2 multimode interference waveguide 31b, respectively. The pair of third arm waveguides 32 and 33 is connected to two input ports of the 2×1 multimode interference waveguide 34b, respectively.

The first 2×2 Mach-Zehnder optical phase modulation unit 10 is disposed halfway on one of the pair of third arm waveguides 32 and 33 (for example, the third arm waveguide 32). Specifically, the first 2×2 multimode interference waveguide 11 of the first 2×2 Mach-Zehnder optical phase modulation unit 10 is connected to a first portion 32p of the third arm waveguide 32. The first portion 32p of the third arm waveguide 32 is connected to the first 1×2 multimode interference waveguide 31b. The 2×1 multimode interference waveguide 34b of the first 2×2 Mach-Zehnder optical phase modulation unit 10 is connected to a second portion 32q of the third arm waveguide 32. The second portion 32q of the third arm waveguide 32 is connected to the 2×1 multimode interference waveguide 34b.

The second 2×2 Mach-Zehnder optical phase modulation unit 20 is disposed halfway on the other of the pair of third arm waveguides 32 and 33 (for example, the third arm waveguide 33). Specifically, the third 2×2 multimode interference waveguide 21 of the second 2×2 Mach-Zehnder optical phase modulation unit 20 is connected to a first portion 33p of the third arm waveguide 33. The first portion 33p of the third arm waveguide 33 is connected to the first 1×2 multimode interference waveguide 31b. The fourth 2×2 multimode interference waveguide 24 of the second 2×2 Mach-Zehnder optical phase modulation unit 20 is connected to a second portion 33q of the third arm waveguide 33. The second portion 33q of the third arm waveguide 33 is connected to the 2×1 multimode interference waveguide 34b.

The input waveguide connected to the input port 37a of the Mach-Zehnder optical waveguide unit 30b extends to the first end face of the substrate 5. The light-emitting member 3 faces the input waveguide. The light is emitted from the light-emitting member 3 to the input port 37a of the Mach-Zehnder optical waveguide portion 30b. The output waveguide connected to the output port 37c of the Mach-Zehnder optical waveguide unit 30b extends to the second end face of the substrate 5. The light-receiving member 4 faces the output waveguide. The phase-modulated optical signal is emitted from the output port 37c of the Mach-Zehnder optical waveguide unit 30b toward the light-receiving member 4.

In the optical phase modulation system 1b (the optical phase modulator 2b), the first output port of the first 2×2 Mach-Zehnder optical phase modulation unit 10 is a first cross port to the first input port of the first 2×2 Mach-Zehnder optical phase modulation unit 10. The second output port of the second 2×2 Mach-Zehnder optical phase modulation unit 20 is a second cross port to the second input port of the second 2×2 Mach-Zehnder optical phase modulation unit 20.

Specifically, the input port 17b of the first 2×2 Mach-Zehnder optical phase modulation unit 10 is a first input port of the first 2×2 Mach-Zehnder optical phase modulation unit 10. The output port 17c of the first 2×2 Mach-Zehnder optical phase modulation unit 10 is a first output port of the first 2×2 Mach-Zehnder optical phase modulation unit 10. The input port 17b of the first 2×2 Mach-Zehnder optical phase modulation unit 10 is connected to the first portion 32p of the third arm waveguide 32. The output port 17c of the first 2×2 Mach-Zehnder optical phase modulation unit 10 is connected to the second portion 32q of the third arm waveguide 32.

The input port 27a of the second 2×2 Mach-Zehnder optical phase modulation unit 20 is a second input port of the second 2×2 Mach-Zehnder optical phase modulation unit 20. The output port 27d of the second 2×2 Mach-Zehnder optical phase modulation unit 20 is a second output port of the second 2×2 Mach-Zehnder optical phase modulation unit 20. The input port 27a of the second 2×2 Mach-Zehnder optical phase modulation unit 20 is connected to the first portion 33p of the third arm waveguide 33. The output port 27d of the second 2×2 Mach-Zehnder optical phase modulation unit 20 is connected to the second portion 33q of the third arm waveguide 33.

The light which is phase-modulated by applying a voltage to each of the first modulation electrodes 15 and 16 and the second modulation electrodes 25 and 26 passes through the second 2×2 multimode interference waveguide 14, the fourth 2×2 multimode interference waveguide 24, and the 2×1 multimode interference waveguide 34b, and is emitted from the optical phase modulator 2b.

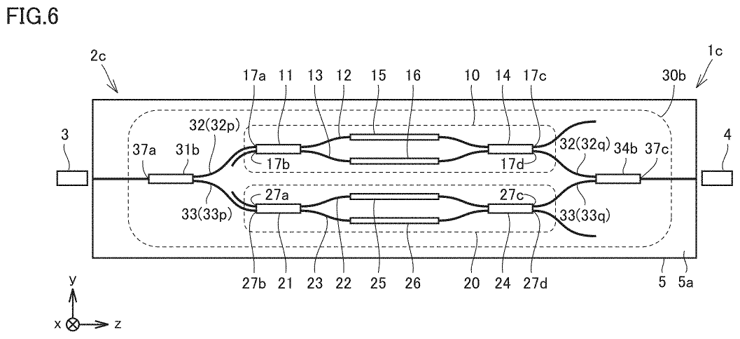

With reference to FIG. 6, in an optical phase modulation system 1c (an optical phase modulator 2c) according to a first modification of the present embodiment, the first output port of the first 2×2 Mach-Zehnder optical phase modulation unit 10 is a first cross port to the first input port of the first 2×2 Mach-Zehnder optical phase modulation unit 10. The second output port of the second 2×2 Mach-Zehnder optical phase modulation unit 20 is a second cross port to the second input port of the second 2×2 Mach-Zehnder optical phase modulation unit 20.

Specifically, the input port 17a of the first 2×2 Mach-Zehnder optical phase modulation unit 10 is a first input port of the first 2×2 Mach-Zehnder optical phase modulation unit 10. The output port 17d of the first 2×2 Mach-Zehnder optical phase modulation unit 10 is a first output port of the first 2×2 Mach-Zehnder optical phase modulation unit 10. The input port 17a of the first 2×2 Mach-Zehnder optical phase modulation unit 10 is connected to the first portion 32p of the third arm waveguide 32. The output port 17d of the first 2×2 Mach-Zehnder optical phase modulation unit 10 is connected to the second portion 32q of the third arm waveguide 32.

The input port 27b of the second 2×2 Mach-Zehnder optical phase modulation unit 20 is a second input port of the second 2×2 Mach-Zehnder optical phase modulation unit 20. The output port 27c of the second 2×2 Mach-Zehnder optical phase modulation unit 20 is a second output port of the second 2×2 Mach-Zehnder optical phase modulation unit 20. The input port 27b of the second 2×2 Mach-Zehnder optical phase modulation unit 20 is connected to the first portion 33p of the third arm waveguide 33. The output port 27c of the second 2×2 Mach-Zehnder optical phase modulation unit 20 is connected to the second portion 33q of the third arm waveguide 33.

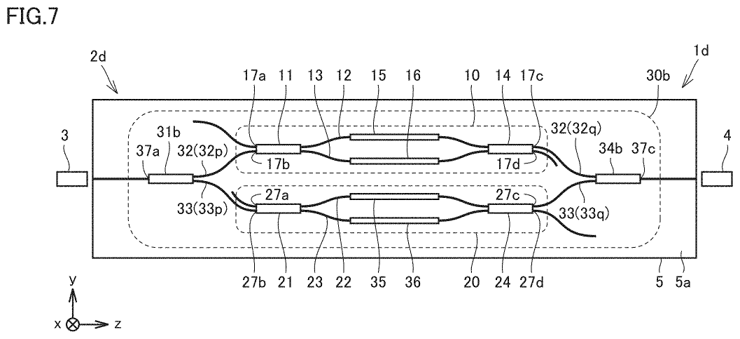

With reference to FIG. 7, in an optical phase modulation system 1d (an optical phase modulator 2d) according to a second modification of the present embodiment, the first output port of the first 2×2 Mach-Zehnder optical phase modulation unit 10 is a first cross port to the first input port of the first 2×2 Mach-Zehnder optical phase modulation unit 10. The second output port of the second 2×2 Mach-Zehnder optical phase modulation unit 20 is a second cross port to the second input port of the second 2×2 Mach-Zehnder optical phase modulation unit 20.

Specifically, the input port 17b of the first 2×2 Mach-Zehnder optical phase modulation unit 10 is a first input port of the first 2×2 Mach-Zehnder optical phase modulation unit 10. The output port 17c of the first 2×2 Mach-Zehnder optical phase modulation unit 10 is a first output port of the first 2×2 Mach-Zehnder optical phase modulation unit 10. The input port 17b of the first 2×2 Mach-Zehnder optical phase modulation unit 10 is connected to the first portion 32p of the third arm waveguide 32. The output port 17c of the first 2×2 Mach-Zehnder optical phase modulation unit 10 is connected to the second portion 32q of the third arm waveguide 32.

The input port 27b of the second 2×2 Mach-Zehnder optical phase modulation unit 20 is a second input port of the second 2×2 Mach-Zehnder optical phase modulation unit 20. The output port 27c of the second 2×2 Mach-Zehnder optical phase modulation unit 20 is a second output port of the second 2×2 Mach-Zehnder optical phase modulation unit 20. The input port 27b of the second 2×2 Mach-Zehnder optical phase modulation unit 20 is connected to the first portion 33p of the third arm waveguide 33. The output port 27c of the second 2×2 Mach-Zehnder optical phase modulation unit 20 is connected to the second portion 33q of the third arm waveguide 33.

Effects of the optical phase modulator 2b, 2c or 2d of the present embodiment will be described. The optical phase modulator 2b, 2c or 2d of the present embodiment has the following effects in addition to the effects of the optical phase modulator 2 of the first embodiment.

The optical phase modulator 2b, 2c or 2d of the present embodiment further includes a second 2×2 Mach-Zehnder optical phase modulation unit 20 and a Mach-Zehnder optical waveguide unit 30b. The second 2×2 Mach-Zehnder optical phase modulation unit 20 includes a third 2×2 multimode interference waveguide 21, a fourth 2×2 multimode interference waveguide 24, a pair of second arm waveguides 22 and 23, and second modulation electrodes 25 and 26. The pair of second arm waveguides 22 and 23 connects the third 2×2 multimode interference waveguide 21 and the fourth 2×2 multimode interference waveguide 24 to each other. The second modulation electrodes 25 and 26 are disposed corresponding to the pair of second arm waveguides 22 and 23. The second output port of the second 2×2 Mach-Zehnder optical phase modulation unit 20 is a second cross port to the second input port of the second 2×2 Mach-Zehnder optical phase modulation unit 20. The Mach-Zehnder optical waveguide unit 30b includes a first 1×2 multimode interference waveguide 31b, a 2×1 multimode interference waveguide 34b, and a pair of third arm waveguides 32 and 33. The pair of third arm waveguides 32 and 33 connects 1×2 multimode interference waveguide and the 2×1 multimode interference waveguide 34b to each other. The first 2×2 Mach-Zehnder optical phase modulation unit 10 is disposed halfway on one of the pair of third arm waveguides 32 and 33 (for example, the third arm waveguide 32). The second 2×2 Mach-Zehnder optical phase modulation unit 20 is disposed halfway on the other of the pair of third arm waveguides 32 and 33 (for example, the third arm waveguide 33).

The third 2×2 multimode interference waveguide 21 is an optical demultiplexer in the second 2×2 Mach-Zehnder optical phase modulation unit 20. The fourth 2×2 multimode interference waveguide 24 is an optical multiplexer in the second 2×2 Mach-Zehnder optical phase modulation unit 20. The multimode interference waveguide has a branching ratio deviation caused by a manufacturing errors smaller than that of a Y-branched optical waveguide or a directional coupler. Therefore, the extinction ratio of the optical phase modulator 2b, 2c or 2d (the second 2×2 Mach-Zehnder optical phase modulation unit 20) is improved. Thereby, the quality of the optical phase modulation signal output from the optical phase modulator 2b, 2c or 2d (the second 2×2 Mach-Zehnder optical phase modulation unit 20) is improved.

Further, the second output port of the second 2×2 Mach-Zehnder optical phase modulation unit 20 is a first cross port to the second input port of the second 2×2 Mach-Zehnder optical phase modulation unit 20. Therefore, the branching ratio deviation of the third 2×2 multimode interference waveguide 21 caused by a manufacturing error of the third 2×2 multimode interference waveguide 21 is canceled by the branching ratio deviation of the fourth 2×2 multimode interference waveguide 24 caused by a manufacturing error of the fourth 2×2 multimode interference waveguide 24. The extinction ratio of the optical phase modulator 2b, 2c or 2d (the second 2×2 Mach-Zehnder optical phase modulation unit 20) is improved. Thereby, the quality of the optical phase modulation signal output from the optical phase modulator 2b, 2c or 2d is improved.

The first 1×2 multimode interference waveguide 31b is an optical demultiplexer in the Mach-Zehnder optical waveguide unit 30b. The 2×1 multimode interference waveguide 34b is an optical demultiplexer in the Mach-Zehnder optical waveguide unit 30b. The multimode interference waveguide has a branching ratio deviation caused by a manufacturing error smaller than that of a Y-branched optical waveguide or a directional coupler. Therefore, the extinction ratio of the optical phase modulator 2b, 2c or 2d (the Mach-Zehnder optical waveguide portion 30b) is improved. Thereby, the quality of the optical phase modulation signal output from the optical phase modulator 2b, 2c or 2d is improved.

### Third Embodiment

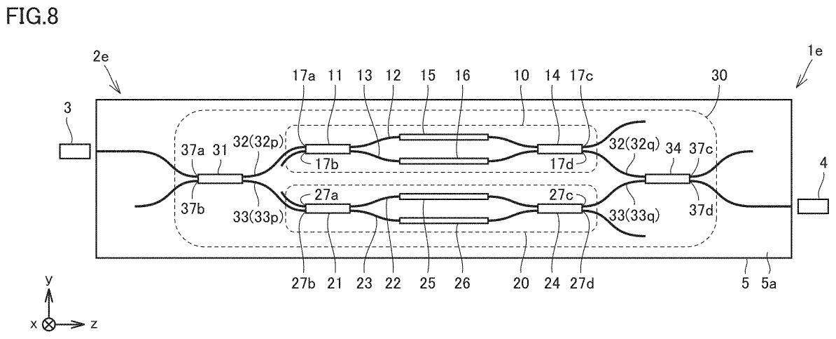

An optical phase modulation system 1e according to a third embodiment will be described with reference to FIG. 8. The optical phase modulation system 1e of the present embodiment has a structure similar to that of the optical phase modulation system 1c (see FIG. 6) according to the first modification of the second embodiment, but is mainly different from the optical phase modulation system 1c in that the optical phase modulation system 1e of the present embodiment includes an optical phase modulator 2e instead of the optical phase modulator 2c according to the first modification of the second embodiment. The optical phase modulator 2e has a structure similar to that of the optical phase modulator 2c according to the first modification of the second embodiment, but is mainly different from the optical phase modulator 2c on the following points.

In the optical phase modulator 2e, the Mach-Zehnder optical waveguide unit 30 is a 2×2 Mach-Zehnder optical waveguide unit. The Mach-Zehnder optical waveguide unit 30 includes two input ports 37a and 37b and two output ports 37c and 37d.

Specifically, instead of the first 1×2 multimode interference waveguide 31b and the 2×1 multimode interference waveguide 34b (see FIG. 6), the Mach-Zehnder optical waveguide unit 30 includes a fifth 2×2 multimode interference waveguide 31 and a sixth 2×2 multimode interference waveguide 34. The fifth 2×2 multimode interference waveguide 31 has the same structure as the sixth 2×2 multimode interference waveguide 34. The fifth 2×2 multimode interference waveguide 31 has the same structure as the first 2×2 multimode interference waveguide 11.

The fifth 2×2 multimode interference waveguide 31 includes two input ports. The input ports 37a and 37b of the Mach-Zehnder optical waveguide unit 30 are two input ports of the fifth 2×2 multimode interference waveguide 31. The sixth 2×2 multimode interference waveguide 34 includes two output ports. The output ports 37c and 37d of the Mach-Zehnder optical waveguide unit 30 are two output ports of the sixth 2×2 multimode interference waveguide 34.

In a plan view of the main surface 5a of the substrate 5, the input port 37a and the output port 37c are disposed on one side (for example, the upper side in FIG. 8) with respect to a center line of the Mach-Zehnder optical waveguide portion 30 that extends in the longitudinal direction of the Mach-Zehnder optical waveguide portion 30. In a plan view of the main surface 5a of the substrate 5, the input port 37b and the output port 37d are disposed on the other side (for example, the lower side in FIG. 8) with respect to the center line of the Mach-Zehnder optical waveguide portion 30 that extends in the longitudinal direction of the Mach-Zehnder optical waveguide portion 30.

The pair of third arm waveguides 32 and 33 has the same structure as the pair of first arm waveguides 12 and 13. Each of the pair of third arm waveguides 32 and 33 is a single mode waveguide. The pair of third arm waveguides 32 and 33 connects the fifth 2×2 multimode interference waveguide 31 and the sixth 2×2 multimode interference waveguide 34 to each other. The pair of third arm waveguides 32 and 33 is connected to two output ports of the fifth 2×2 multimode interference waveguide 31, respectively. The pair of third arm waveguides 32 and 33 is connected to two input ports of the sixth 2×2 multimode interference waveguide 34, respectively.

In the optical phase modulation system 1e (the optical phase modulator 2e), the third output port of the Mach-Zehnder optical waveguide unit 30 is a third cross port to the third input port of the Mach-Zehnder optical waveguide unit 30.

Specifically, the input port 37a of the Mach-Zehnder optical waveguide unit 30 is a third input port of the Mach-Zehnder optical waveguide unit 30. The output port 37d of the Mach-Zehnder optical waveguide unit 30 is a third output port of the Mach-Zehnder optical waveguide unit 30. The input waveguide connected to the input port 37a extends to the first end face of the substrate 5. The light-emitting member 3 faces the input waveguide. The light is emitted from the light-emitting member 3 to the input port 37a. The output waveguide connected to the output port 37d extends to the second end face of the substrate 5. The light-receiving member 4 faces the output waveguide. The phase-modulated optical signal is emitted from the output port 37d toward the light-receiving member 4.

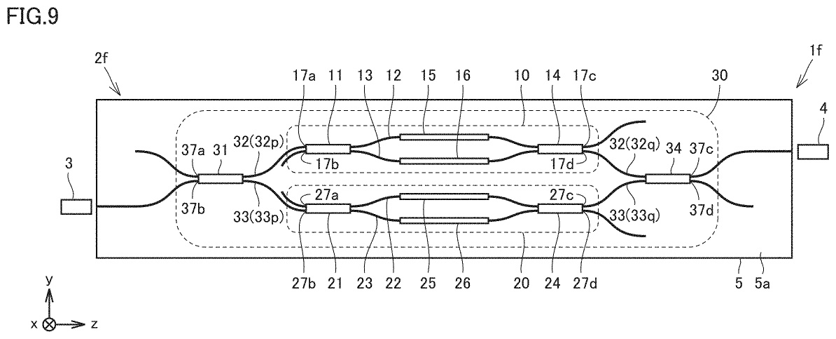

With reference to FIG. 9, in an optical phase modulation system 1f (an optical phase modulator 20 according to a modification of the present embodiment, the third output port of Mach-Zehnder optical waveguide unit 30 is a third cross port to the third input port of Mach-Zehnder optical waveguide unit 30.

Specifically, the input port 37b of the Mach-Zehnder optical waveguide unit 30 is a third input port of the Mach-Zehnder optical waveguide unit 30. The output port 37c of the Mach-Zehnder optical waveguide unit 30 is a third output port of the Mach-Zehnder optical waveguide unit 30. The input waveguide connected to the input port 37b extends to the first end face of the substrate 5. The light-emitting member 3 faces the input waveguide. The light is emitted from the light-emitting member 3 to the input port 37b. The output waveguide connected to the output port 37c extends to the second end face of the substrate 5. The light-receiving member 4 faces the output waveguide. The phase-modulated optical signal is emitted from the output port 37c toward the light-receiving member 4.

Effects of the optical phase modulator 2e or 2f of the present embodiment will be described. The optical phase modulator 2e or 2f of the present embodiment has the following effects in addition to the effects of the optical phase modulator 2b, 2c or 2d of the second embodiment.

The optical phase modulator 2e or 2f according to the present embodiment further includes a second 2×2 Mach-Zehnder optical phase modulation unit 20 and a Mach-Zehnder optical waveguide unit 30 which is a 2×2 Mach-Zehnder optical waveguide unit. The second 2×2 Mach-Zehnder optical phase modulation unit 20 includes a third 2×2 multimode interference waveguide 21, a fourth 2×2 multimode interference waveguide 24, a pair of second arm waveguides 22 and 23, and second modulation electrodes 25 and 26. The pair of second arm waveguides 22 and 23 connects the third 2×2 multimode interference waveguide 21 and the fourth 2×2 multimode interference waveguide 24 to each other. The second modulation electrodes 25 and 26 are disposed corresponding to the pair of second arm waveguides 22 and 23. The second output port of the second 2×2 Mach-Zehnder optical phase modulation unit 20 is a second cross port to the second input port of the second 2×2 Mach-Zehnder optical phase modulation unit 20. The Mach-Zehnder optical waveguide unit 30 includes a fifth 2×2 multimode interference waveguide 31, a sixth 2×2 multimode interference waveguide 34, and a pair of third arm waveguides 32 and 33. The pair of third arm waveguides 32 and 33 connects the fifth 2×2 multimode interference waveguide 31 and the sixth 2×2 multimode interference waveguide 34 to each other. The first 2×2 Mach-Zehnder optical phase modulation unit 10 is disposed halfway on one of the pair of third arm waveguides 32 and 33 (for example, the third arm waveguide 32). The second 2×2 Mach-Zehnder optical phase modulation unit 20 is disposed halfway on the other of the pair of third arm waveguides 32 and 33 (for example, the third arm waveguide 33). The third output port of the Mach-Zehnder optical waveguide unit 30 is a third cross port to the third input port of the Mach-Zehnder optical waveguide unit 30.

Therefore, the branching ratio deviation of the fifth 2×2 multimode interference waveguide 31 caused by a manufacturing error of the fifth 2×2 multimode interference waveguide 31 is canceled by the branching ratio deviation of the sixth 2×2 multimode interference waveguide 34 caused by a manufacturing error of the sixth 2×2 multimode interference waveguide 34. The extinction ratio of the optical phase modulator 2e or 2f (the Mach-Zehnder optical waveguide unit 30) is improved. Thereby, the quality of the optical phase modulation signal output from the optical phase modulator 2e or 2f is improved.

### Fourth Embodiment

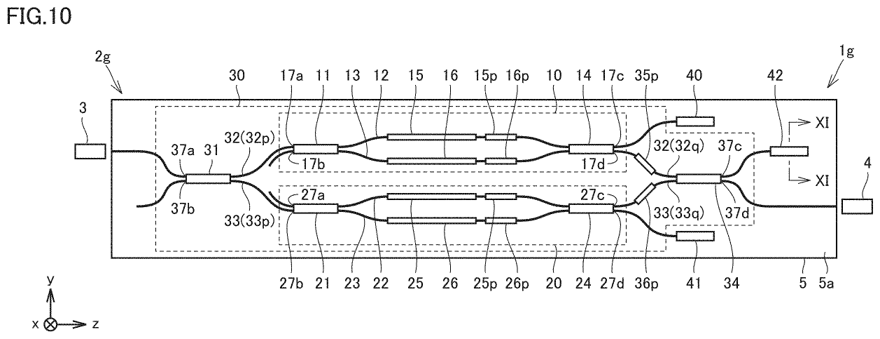

An optical phase modulation system 1g according to a fourth embodiment will be described with reference to FIGS. 10 to 12. The optical phase modulation system 1g of the present embodiment has a structure similar to that of the optical phase modulation system 1e (see FIG. 8) of the third embodiment, but is mainly different from the optical phase modulation system 1e of the present embodiment in that the optical phase modulation system 1g includes an optical phase modulator 2g instead of the optical phase modulator 2e of the third embodiment. The optical phase modulator 2g of the present embodiment has a structure similar to that of the optical phase modulator 2e of the third embodiment, but is mainly different from the optical phase modulator 2e on the following points.

As illustrated in FIG. 10, the optical phase modulator 2g further includes a photodetector 42. The Mach-Zehnder optical waveguide unit 30 further includes phase adjustment electrodes 35p and 36p.

The photodetector 42 is, for example, a photodiode. The photodetector 42 is disposed, for example, on the substrate 5. As illustrated in FIG. 11, the photodetector 42 includes a lower cladding layer 6a, a light absorbing layer 7b formed on the lower cladding layer 6a, an upper cladding layer 6b formed on the light absorbing layer 7b, and a pair of electrodes 8a and 8b. The light absorbing layer 7b has a lower bandgap energy than the lower cladding layer 6a and the upper cladding layer 6b. The light absorbing layer 7b is, for example, a bulk semiconductor layer made of an InGaAsP-based material or a multiple quantum well (MQW) layer. The electrode 8a is formed on the upper cladding layer 6b. The electrode 8b may be formed on a main surface of the substrate 5 opposite to the main surface 5a. The photodetector 42 is, for example, a pin photodiode, and a reverse bias voltage is applied between the electrodes 8a and 8b.

The photodetector 42 is connected to an output port (for example, the output port 37c) of the Mach-Zehnder optical waveguide unit 30 which is different from the third output port (for example, the output port 37d) of the Mach-Zehnder optical waveguide unit 30.

As illustrated in FIG. 10, the phase adjustment electrodes 35p and 36p are disposed corresponding to at least one of the pair of third arm waveguides 32 and 33. For example, the phase adjustment electrodes 35p and 36p may be disposed on at least one of the pair of third arm waveguides 32 and 33. Specifically, the phase adjustment electrodes 35p and 36p are disposed corresponding to at least one of the second portions 32q and 33q of the third arm waveguides 32 and 33. For example, the phase adjustment electrodes 35p and 36p may be disposed on at least one of the second portions 32q and 33q of the third arm waveguides 32 and 33. In order to apply to the phase adjustment electrodes 35p and 36p a phase that may be used to compensate for a phase error of the pair of third arm waveguides 32 and 33 caused by a manufacturing error of the pair of third arm waveguides 32 and 33, a phase adjustment voltage is applied to the phase adjustment electrodes 35p and 36p.

As illustrated in FIG. 10, the optical phase modulator 2g further includes a first photodetector 40 and a second photodetector 41. The first 2×2 Mach-Zehnder optical phase modulation unit 10 further includes first phase adjustment electrodes 15p and 16p. The second 2×2 Mach-Zehnder optical phase modulation unit 20 further includes second phase adjustment electrodes 25p and 26p.

Each of the first photodetector 40 and the second photodetector 41 is, for example, a photodiode. The first photodetector 40 and the second photodetector 41 are arranged, for example, on the substrate 5. Each of the first photodetector 40 and the second photodetector 41 has a laminated structure the same as that of the photodetector 42 illustrated in FIG. 11. The first photodetector 40 is connected to an output port (for example, the output port 17c) of the first 2×2 Mach-Zehnder optical phase modulation unit 10 which is different from the first output port (for example, the output port 17d) of the first 2×2 Mach-Zehnder optical phase modulation unit 10. The second photodetector 41 is connected to an output port (for example, the output port 27d) of a second 2×2 Mach-Zehnder optical phase modulation unit 20 which is different from the second output port (for example, the output port 27c) of the second 2×2 Mach-Zehnder optical phase modulation unit 20.

The first phase adjustment electrodes 15p and 16p are disposed corresponding to at least one of the pair of first arm waveguides 12 and 13. For example, the first phase adjustment electrodes 15p and 16p may be disposed on at least one of the pair of first arm waveguides 12 and 13. Specifically, the first phase adjustment electrodes 15p and 16p are disposed between the first modulation electrodes 15 and 16 and the second 2×2 multimode interference waveguide 14. In order to apply to the pair of first arm waveguides 12 and 13 a phase that may be used to compensate for a phase error of the pair of first arm waveguides 12 and 13 caused by a manufacturing error of the pair of first arm waveguides 12 and 13, a first phase adjustment voltage is applied to the first phase adjustment electrodes 15p and 16p.

The second phase adjustment electrodes 25p and 26p are disposed corresponding to at least one of the pair of second arm waveguides 22 and 23. For example, the second phase adjustment electrodes 25p and 26p may be disposed on at least one of the pair of second arm waveguides 22 and 23. Specifically, the second phase adjustment electrodes 25p and 26p are disposed between the second modulation electrodes 25 and 26 and the fourth 2×2 multimode interference waveguide 24. In order to apply to the pair of second arm waveguides 22 and 23 a phase that may be used to compensate for a phase error of the pair of second arm waveguides 22 and 23 caused by a manufacturing error of the pair of second arm waveguides 22 and 23, a second phase adjustment voltage is applied to the second phase adjustment electrodes 25p and 26p.

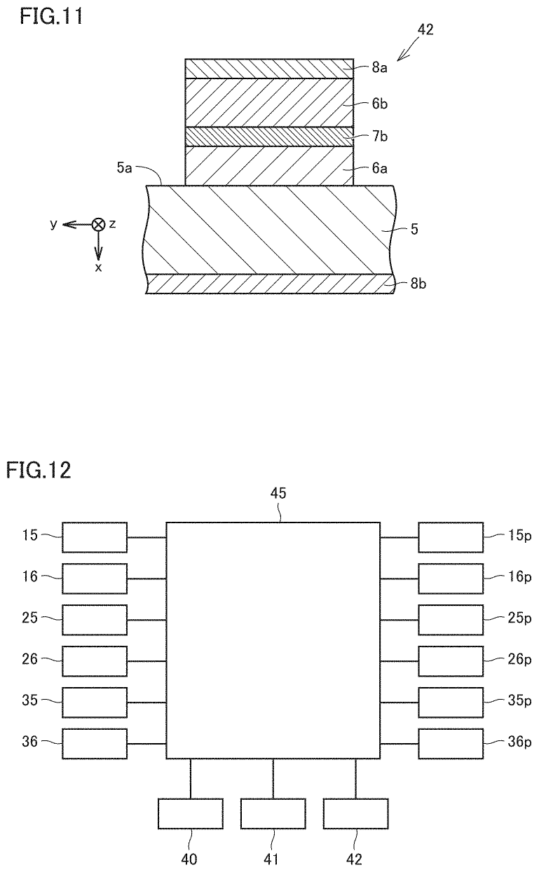

As illustrated in FIG. 12, the optical phase modulator 2g further includes a controller 45. The controller 45 is formed of, for example, a semiconductor processor such as a central processing unit (CPU). The controller 45 is configured to receive the intensity of a light beam detected by the photodetector 42 and output a phase adjustment voltage corresponding to the intensity of the light beam to the phase adjustment electrodes 35p and 36p. The controller 45 is configured to receive the intensity of a light beam detected by the first photodetector 40 and output a first phase adjustment voltage corresponding to the intensity of the light beam to the first phase adjustment electrodes 15p and 16p. The controller 45 is configured to receive the intensity of a light beam detected by the second photodetector 41 and output a second phase adjustment voltage corresponding to the intensity of the light beam to the second phase adjustment electrodes 25p and 26p.

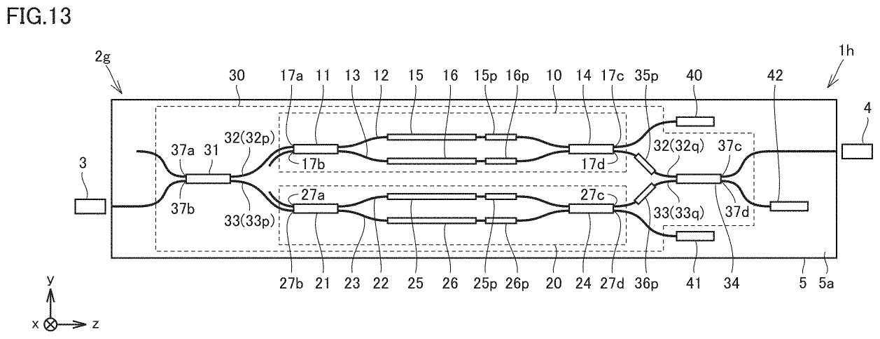

With reference to FIG. 13, in an optical phase modulation system 2h (an optical phase modulator 2h) according to a first modification of the present embodiment, similar to the optical phase modulation system 1f (the optical phase modulator 2f) (see FIG. 9) according to a modification of the third embodiment, the input port 37b of Mach-Zehnder optical waveguide unit 30 is a third input port of Mach-Zehnder optical waveguide unit 30. The output port 37c of the Mach-Zehnder optical waveguide unit 30 is a third output port of the Mach-Zehnder optical waveguide unit 30.

In the optical phase modulation system (the optical phase modulator) according to the second modification of the present embodiment, the first phase adjustment electrodes 15p and 16p and the second phase adjustment electrodes 25p and 26p may be dispensed with. The controller 45 may be configured to receive the intensity of a light beam detected by the first photodetector 40 and output a first phase adjustment voltage corresponding to the intensity of the light beam to the first modulation electrodes 15 and 16. A first modulation voltage and a first phase adjustment voltage may be applied to the first modulation electrodes 15 and 16. The controller 45 may be configured to receive the intensity of a light beam detected by the second photodetector 41 and output a second phase adjustment voltage corresponding to the intensity of the light beam to the second modulation electrodes 25 and 26. A second modulation voltage and a second phase adjustment voltage may be applied to the second modulation electrodes 25 and 26.

Effects of the optical phase modulator 2g or 2h of the present embodiment will be described. The optical phase modulator 2g or 2h of the present embodiment has the following effects in addition to the effects of the optical phase modulator 2e or 2f of the third embodiment.

The optical phase modulator 2g or 2h of the present embodiment further includes a photodetector 42. The Mach-Zehnder optical waveguide unit 30 further includes phase adjustment electrodes 35p and 36p. The photodetector 42 is connected to an output port of the Mach-Zehnder optical waveguide unit 30 which is different from the third output port of the Mach-Zehnder optical waveguide unit 30. The phase adjustment electrodes 35p and 36p are disposed corresponding to at least one of the pair of third arm waveguides 32 and 33.

Therefore, a phase adjustment voltage may be applied to the phase adjustment electrodes 35p and 36p based on the intensity of a light beam detected by the photodetector 42, which makes it possible to compensate for the phase error of the pair of first arm waveguides 12 and 13 caused by a manufacturing error of the pair of first arm waveguides 12 and 13. The extinction ratio of the Mach-Zehnder optical waveguide unit 30 is improved. Thereby, the quality of the optical phase modulation signal output from the optical phase modulator 2g or 2h is improved.

The optical phase modulator 2g or 2h of the present embodiment further includes a first photodetector 40 and a second photodetector 41. The first 2×2 Mach-Zehnder optical phase modulation unit 10 further includes first phase adjustment electrodes 15p and 16p. The second 2×2 Mach-Zehnder optical phase modulation unit 20 further includes second phase adjustment electrodes 25p and 26p. The first photodetector 40 is connected to an output port of the first 2×2 Mach-Zehnder optical phase modulation unit 10 which is different from the first output port of the first 2×2 Mach-Zehnder optical phase modulation unit 10. The second photodetector 41 is connected to an output port of the second 2×2 Mach-Zehnder optical phase modulation unit 20 which is different from the second output port of the second 2×2 Mach-Zehnder optical phase modulation unit 20. The first phase adjustment electrodes 15p and 16p are disposed corresponding to at least one of the pair of first arm waveguides 12 and 13. The second phase adjustment electrodes 25p and 26p are disposed corresponding to at least one of the pair of second arm waveguides 22 and 23.

Therefore, a first phase adjustment voltage may be applied to the first phase adjustment electrodes 15p and 16p based on a first light intensity detected by the first photodetector 40, which makes it possible to compensate for the phase error of the pair of first arm waveguides 12 and 13 caused by a manufacturing error of the pair of first arm waveguides 12 and 13. A second phase adjustment voltage may be applied to the second phase adjustment electrodes 25p and 26p based on a second light intensity detected by the second photodetector 41, which makes it possible to compensate for the phase error of the pair of second arm waveguides 22 and 23 caused by a manufacturing error of the pair of second arm waveguides 22 and 23. The extinction ratio of the first 2×2 Mach-Zehnder optical phase modulation unit 10 and the extinction ratio of the second 2×2 Mach-Zehnder optical phase modulation unit 20 are improved. Thereby, the quality of the optical phase modulation signal output from the optical phase modulator 2g or 2h is improved.

### Fifth Embodiment

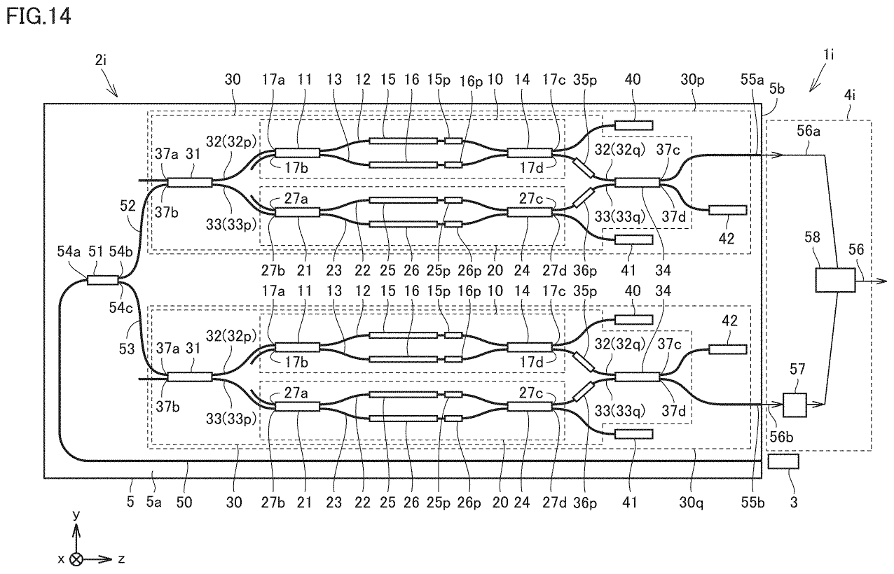

With reference to FIG. 14, an optical phase modulation system 1i according to a fifth embodiment will be described. As illustrated in FIG. 14, the optical phase modulation system 1i includes an optical phase modulator 2i, a light-emitting member 3, and a light-receiving member 4i.

The light-emitting member 3 is the same as the light-emitting member 3 of the first embodiment. The optical phase modulator 2i includes an input waveguide 50, an optical demultiplexer (a second 1×2 multimode interference waveguide 51), waveguides 52 and 53, a first multilevel optical phase modulation unit 30p, and a second multilevel optical phase modulation unit 30q. The optical phase modulator 2i is a dual polarization in-phase quadrature (DP-IQ) optical modulator capable of performing polarization-multiplexed quadrature phase shift keying (DP-QPSK).

The input waveguide 50, the optical demultiplexer (the second 1×2 multimode interference waveguide 51), and the waveguides 52 and 53 are formed on the main surface 5a of the substrate 5. The optical demultiplexer is formed of the second 1×2 multimode interference waveguide 51. The second 1×2 multimode interference waveguide 51 includes an input port 54a and two output ports 54b and 54c. Each of the input waveguide 50 and the waveguides 52 and 53 is a single mode waveguide. The input waveguide 50 extends from the end face 5b of the substrate 5 to the input port 54a of the second 1×2 multimode interference waveguide 51.

The first multilevel optical phase modulation unit 30p has the same structure as any one of the optical phase modulators 2b, 2c, 2d, 2e, 2f, 2g and 2h according to the second to fourth embodiments and the modifications thereof. In the present embodiment, the first multilevel optical phase modulation unit 30p has the same structure as the optical phase modulator 2h (see FIG. 13) according to the first modification of the fourth embodiment. In other words, the first multilevel optical phase modulation unit 30p includes a first 2×2 Mach-Zehnder optical phase modulation unit 10, a second 2×2 Mach-Zehnder optical phase modulation unit 20, a Mach-Zehnder optical waveguide unit 30, a photodetector 42, a first photodetector 40, and a second photodetector 41, which are included in the optical phase modulator 2h according to the first modification of the fourth embodiment. The first multilevel optical phase modulation unit 30p is an optical modulator capable of performing quadrature phase shift keying (QPSK). The first multilevel optical phase modulation unit 30p outputs a first phase-modulated optical signal 56a.

The second multilevel optical phase modulation unit 30q has the same structure as any one of the optical phase modulators 2b, 2c, 2d, 2e, 2f, 2g and 2h according to the second to fourth embodiments and the modifications thereof. In the present embodiment, the second multilevel optical phase modulation unit 30q has the same structure as the optical phase modulator 2g (see FIG. 10) of the fourth embodiment. In other words, the second multilevel optical phase modulation unit 30q includes a first 2×2 Mach-Zehnder optical phase modulation unit 10, a second 2×2 Mach-Zehnder optical phase modulation unit 20, a Mach-Zehnder optical waveguide unit 30, a photodetector 42, a first photodetector 40, and a second photodetector 41, which are included in the optical phase modulator 2g of the fourth embodiment. The second multilevel optical phase modulation unit 30q is an optical modulator capable of performing quadrature phase shift keying (QPSK). The second multilevel optical phase modulation unit 30q outputs a second phase-modulated optical signal 56b.

The first multilevel optical phase modulation unit 30p is connected to one output port (for example, the output port 54b) of the optical demultiplexer (the second 1×2 multimode interference waveguide 51). Specifically, the input port 37b of the first multilevel optical phase modulator 30p is connected to the output port 54b of the second 1×2 multimode interference waveguide 51 through the waveguide 52. The second multilevel optical phase modulation unit 30q is connected to the other output port (for example, the output port 54c) of the optical demultiplexer (the second 1×2 multimode interference waveguide 51). Specifically, the input port 37a of the second multilevel optical phase modulator 30q is connected to the output port 54c of the second 1×2 multimode interference waveguide 51 through the waveguide 53.

The first output waveguide 55a connected to the output port 37c of the first multilevel optical phase modulation unit 30p extends to the end face 5b of the substrate 5. The second output waveguide 55b connected to the output port 37d of the second multilevel optical phase modulation unit 30q extends to the end face 5b of the substrate 5.

The light-receiving member 4i is an optical multiplexer that combines the first phase-modulated optical signal 56a output from the first multilevel optical phase modulation unit 30p and the second phase-modulated optical signal 56b output from the second multilevel optical phase modulation unit 30q and outputs the combined signal. Specifically, the light-receiving member 4i is a polarization multiplexing optical system which combines a first phase-modulated optical signal 56a having a first polarization (for example, X polarization) and a second phase-modulated optical signal 56b having a second polarization (for example, Y polarization) perpendicular to the first polarization.

Specifically, the light-receiving member 4i includes a polarization rotator 57 and a polarization multiplexer 58. The first multilevel optical phase modulation unit 30p (or the first output waveguide 55a) outputs a first phase-modulated optical signal 56a having a first polarization (for example, X polarization). The second multilevel optical phase modulation unit 30q (or the second output waveguide 55b) outputs a second phase-modulated optical signal 56b having a first polarization (for example, X polarization). The polarization rotator 57 rotates the polarization of the second phase-modulated optical signal 56b by 90° and outputs a second phase-modulated optical signal 56b having a second polarization (for example, Y polarization). The polarization multiplexer 58 is, for example, a polarization beam splitter. The polarization multiplexer 58 combines the first phase-modulated optical signal 56a having the first polarization and the second phase-modulated optical signal 56b having the second polarization, and outputs the phase-modulated optical signal 56 as a polarization-multiplexed quadrature phase shift keying (DP-QPSK) signal.

Effects of the optical phase modulator 2i of the present embodiment will be described. The optical phase modulator 2i of the present embodiment has the following effects in addition to the effects of the optical phase modulator 2g or 2h of the fourth embodiment.

The optical phase modulator 2i of the present embodiment includes an optical demultiplexer, a first multilevel optical phase modulation unit 30p, and a second multilevel optical phase modulation unit 30q. The optical demultiplexer is formed of a second 1×2 multimode interference waveguide 51. The first multilevel optical phase modulation unit 30p is connected to one output port (for example, the output port 54b) of the optical demultiplexer and outputs a first phase-modulated optical signal 56a. The second multilevel optical phase modulation unit 30q is connected to the other output port (for example, the output port 54c) of the optical demultiplexer and outputs a second phase-modulated optical signal 56b. Each of the first multilevel optical phase modulation unit 30p and the second multilevel optical phase modulation unit 30q includes a first 2×2 Mach-Zehnder optical phase modulation unit 10, a second 2×2 Mach-Zehnder optical phase modulation unit 20, and Mach-Zehnder optical waveguide units 30 and 30b included in any of the optical phase modulators 2b, 2c, 2d, 2e, 2f, 2g and 2h of the second embodiment, the third embodiment and the fourth embodiment.

Therefore, the optical phase modulator 2i can output more multiplexed phase-modulated optical signals.

The optical phase modulation system 1i of the present embodiment includes the optical phase modulator 2i of the present embodiment and a polarization multiplexing optical system (the light-receiving member 4i). The polarization multiplexing optical system includes a polarization rotator 57 and a polarization multiplexer 58. The polarization multiplexer 58 combines a first phase-modulated optical signal 56a having a first polarization and a second phase-modulated optical signal 56b having a second polarization perpendicular to the first polarization which is rotated by the polarization rotator 57.

Therefore, the optical phase modulation system 1i can output more multiplexed phase-modulated optical signals.

It should be understood that the first to fifth embodiments and the modified examples thereof disclosed herein are illustrative and not restrictive in all respects. At least two of the first embodiment to the fifth embodiment disclosed herein may be combined unless they are inconsistent to each other. It is intended that the scope of the present invention is not limited to the description above but defined by the scope of the claims and encompasses all modifications equivalent in meaning and scope to the claims.

### REFERENCE SIGNS LIST

1, 1b, 1c, 1d, 1e, 1f, 1g, 1h, 1i: optical phase modulation system; 2, 2b, 2c, 2d, 2e, 2f, 2g, 2h, 2i: optical phase modulator; 3: light-emitting member; 4, 4i: light-receiving member; 5: substrate; 5a: main surface; 5b: end face; 6a: lower cladding layer; 6b: upper cladding layer; 7: optical waveguide layer; 7b: light absorbing layer; 8a, 8b: electrode; 10: first 2×2 Mach-Zehnder optical phase modulation unit; 11: first 2×2 multimode interference waveguide; 12, 13: first arm waveguide; 14: second 2×2 multimode interference waveguide; 15, 16: first modulation electrode; 15p, 16p: first phase adjustment electrode; 17a, 17b: input port; 17c, 17d: output port; 20: second 2×2 Mach-Zehnder optical phase modulation unit; 21: third 2×2 multimode interference waveguide; 22, 23: second arm waveguide; 24: fourth 2×2 multimode interference waveguide; 25, 26: second modulation electrode; 25p, 26p: second phase adjustment electrode; 27a, 27b: input port; 27c, 27d: output port; 30, 30b: Mach-Zehnder optical waveguide unit; 30p: first multilevel optical phase modulation unit; 30q: second multilevel optical phase modulation unit; 31: fifth 2×2 multimode interference waveguide; 31b: first 1×2 multimode interference waveguide; 32, 33: third arm waveguide; 32p, 33p: first portion; 32q, 33q: second portion; 34: sixth 2×2 multimode interference waveguide; 34b: 2×1 multimode interference waveguide; 35p, 36p: phase adjustment electrode; 37a, 37b: input port; 37c, 37d: output port; 40: first photodetector; 41: second photodetector; 42: photodetector; 45: controller; 50: input waveguide; 51: second 1×2 multimode interference waveguide; 52, 53: waveguide; 54a: input port; 54b, 54c: output port; 55a: first output waveguide; 55b: second output waveguide; 56: phase-modulated optical signal; 56a: first phase-modulated optical signal; 56b: second phase-modulated optical signal; 57: polarization rotator; 58: polarization multiplexer

1. An optical phase modulator comprising:
a first 2×2 Mach-Zehnder optical phase modulation unit,
the first 2×2 Mach-Zehnder optical phase modulation unit including:
a first 2×2 multimode interference waveguide;
a second 2×2 multimode interference waveguide;
a pair of first arm waveguides connecting the first 2×2 multimode interference waveguide and the second 2×2 multimode interference waveguide to each other; and
a first modulation electrode disposed corresponding to the pair of first arm waveguides,
a first output port of the first 2×2 Mach-Zehnder optical phase modulation unit being a first cross port to a first input port of the first 2×2 Mach-Zehnder optical phase modulation unit.

2. The optical phase modulator according to claim 1, further comprising:
a second 2×2 Mach-Zehnder optical phase modulation unit; and
a Mach-Zehnder optical waveguide unit,
wherein the second 2×2 Mach-Zehnder optical phase modulation unit includes:
a third 2×2 multimode interference waveguide;
a fourth 2×2 multimode interference waveguide;
a pair of second arm waveguides connecting the third 2×2 multimode interference waveguide and the fourth 2×2 multimode interference waveguide to each other; and
a second modulation electrode disposed corresponding to the pair of second arm waveguides,
a second output port of the second 2×2 Mach-Zehnder optical phase modulation unit is a second cross port to the second input port of the second 2×2 Mach-Zehnder optical phase modulation unit,
the Mach-Zehnder optical waveguide unit includes:
a first 1×2 multimode interference waveguide;
a 2×1 multimode interference waveguide; and
a pair of third arm waveguides connecting the first 1×2 multimode interference waveguide and the 2×1 multimode interference waveguide to each other,
the first 2×2 Mach-Zehnder optical phase modulation unit is disposed halfway on one of the pair of third arm waveguides, and
the second 2×2 Mach-Zehnder optical phase modulation unit is disposed halfway on the other of the pair of third arm waveguides.

3. The optical phase modulator according to claim 1, further comprising:
a second 2×2 Mach-Zehnder optical phase modulation unit; and
a Mach-Zehnder optical waveguide unit which is a 2×2 Mach-Zehnder optical waveguide unit,
wherein the second 2×2 Mach-Zehnder optical phase modulation unit includes:
a third 2×2 multimode interference waveguide;
a fourth 2×2 multimode interference waveguide;
a pair of second arm waveguides connecting the third 2×2 multimode interference waveguide and the fourth 2×2 multimode interference waveguide to each other; and
a second modulation electrode disposed corresponding to the pair of second arm waveguides, a second output port of the second 2×2 Mach-Zehnder optical phase modulation unit is a second cross port to the second input port of the second 2×2 Mach-Zehnder optical phase modulation unit,
the Mach-Zehnder optical waveguide unit includes:
a fifth 2×2 multimode interference waveguide;
a sixth 2×2 multimode interference waveguide; and
a pair of third arm waveguides connecting the fifth 2×2 multimode interference waveguide and the sixth 2×2 multimode interference waveguide to each other,
the first 2×2 Mach-Zehnder optical phase modulation unit is disposed halfway on one of the pair of third arm waveguides,
the second 2×2 Mach-Zehnder optical phase modulation unit is disposed halfway on the other of the pair of third arm waveguides, and
a third output port of the Mach-Zehnder optical waveguide unit is a third cross port to the third input port of the Mach-Zehnder optical waveguide unit.

4. The optical phase modulator according to claim 3, further comprising a photodetector,
wherein the Mach-Zehnder optical waveguide unit further includes a phase adjustment electrode,
the photodetector is connected to an output port of the Mach-Zehnder optical waveguide unit which is different from the third output port of the Mach-Zehnder optical waveguide unit, and
the phase adjustment electrode is disposed corresponding to at least one of the pair of third arm waveguides.

5. The optical phase modulator according to any one of claims 2 to 4, further comprising:
a first photodetector; and
a second photodetector,
wherein the first 2×2 Mach-Zehnder optical phase modulation unit further includes a first phase adjustment electrode,
the second 2×2 Mach-Zehnder optical phase modulation unit further includes a second phase adjustment electrode,
the first photodetector is connected to an output port of the first 2×2 Mach-Zehnder optical phase modulation unit which is different from the first output port of the first 2×2 Mach-Zehnder optical phase modulation unit,
the second photodetector is connected to an output port of the second 2×2 Mach-Zehnder optical phase modulation unit which is different from the second output port of the second 2×2 Mach-Zehnder optical phase modulation unit,
the first phase adjustment electrode is disposed corresponding to at least one of the pair of first arm waveguides, and
the second phase adjustment electrode is disposed corresponding to at least one of the pair of second arm waveguides.

6. An optical phase modulator comprising:
an optical demultiplexer formed by a second 1×2 multimode interference waveguide;
a first multilevel optical phase modulation unit connected to one output port of the optical demultiplexer for outputting a first phase-modulated optical signal; and
a second multilevel optical phase modulator connected to the other output port of the optical demultiplexer for outputting a second phase-modulated optical signal,
each of the first multilevel optical phase modulation unit and the second multilevel optical phase modulation unit including the first 2×2 Mach-Zehnder optical phase modulation unit, the second 2×2 Mach-Zehnder optical phase modulation unit, and the Mach-Zehnder optical waveguide unit which are included in the optical phase modulator according to any one of claims 2 to 5.
